(19) United States
(12) Patent Application Publication
(10) Pub. No.: US 2026/0086330 A1
(43) Pub. Date: Mar. 26, 2026

(54) IMAGING LENS SYSTEM

(71) Applicant: Samsung Electro-Mechanics Co., Ltd., Suwon-si (KR)

(72) Inventors: Ju Yeon JO, Suwon-si (KR); Ju Hwa SON, Suwon-si (KR)

(73) Assignee: Samsung Electro-Mechanics Co., Ltd., Suwon-si (KR)

(21) Appl. No.: 19/091,567

(22) Filed: Mar. 26, 2025

(30) Foreign Application Priority Data
Sep. 23, 2024 (KR) 10-2024-0128342

(51) Int. Cl. G02B 13/00; G02B 9/60

(52) U.S. Cl. CPC G02B 13/0045; G02B 9/60

(57) ABSTRACT

An imaging lens system includes a first lens, a second lens, a third lens, a fourth lens, and a fifth lens sequentially disposed in ascending numerical order along an optical axis of the imaging lens system from an object side of the imaging lens system toward an imaging plane of the imaging lens system, wherein the second lens has a positive refractive power and is made of a glass material, the fifth lens is made of a plastic material, and the imaging lens system satisfies the conditional expression f-number<2.10, where f-number is an f-number of the imaging lens system.

### CROSS-REFERENCE TO RELATED APPLICATIONS

This application claims the benefit under 35 USC 119(a) of Korean Patent Application No. 10-2024-0128342 filed on Sep. 23, 2024, in the Korean Intellectual Property Office, the entire disclosure of which is incorporated herein by reference for all purposes.

### BACKGROUND

### 1. Field

The present disclosure relates to an imaging lens system capable of minimizing a phenomenon of a reduction in incident light in a peripheral portion of an optical axis.

### 2. Description of Background

A small surveillance camera may be configured to capture image information within a surveillance zone. For example, the small surveillance camera may be mounted on a front bumper, a rear bumper, or other portion of a vehicle, and may provide a captured image to a driver.

Early small surveillance cameras were designed to capture an image of an obstacle adjacent to a vehicle, and thus not only had a relatively low resolution, but also had a high change in resolution according to a change in temperature between −40° C. and 80° C. To solve a problem like this, small surveillance cameras include lenses made of a glass material. However, it may be difficult for a glass material lens to achieve an angle of incident light required by an image sensor of the camera module, which result in a phenomenon of light reduction at a peripheral portion of the optical axis.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an imaging lens system includes a first lens, a second lens, a third lens, a fourth lens, and a fifth lens sequentially disposed in ascending numerical order along an optical axis of the imaging lens system from an object side of the imaging lens system toward an imaging plane of the imaging lens system, wherein the second lens has a positive refractive power and is made of a glass material, the fifth lens is made of a plastic material, and the imaging lens system satisfies the conditional expression f-number<2.10, where f-number is an f-number of the imaging lens system.

The first lens may have a negative refractive power.

The first lens may have a concave object-side surface in a paraxial region thereof.

The second lens may have a convex object-side surface in a paraxial region thereof.

The third lens may have a convex object-side surface in a paraxial region thereof.

The fourth lens may have a concave object-side surface in a paraxial region thereof.

The fifth lens may have a negative refractive power.

The fifth lens may have a convex object-side surface in a paraxial region thereof.

The imaging lens system may satisfy the conditional expression 2.0<f1/f5<20.0, where f1 is a focal length of the first lens, and f5 is a focal length of the fifth lens.

In another general aspect, an imaging lens system includes a first lens, a second lens, a third lens, a fourth lens, and a fifth lens sequentially disposed in ascending numerical order along an optical axis of the imaging lens system from an object side of the imaging lens system toward an imaging plane of the imaging lens system, wherein the first lens has a negative refractive power, the first lens has a convex image-side surface in a paraxial region thereof or the third lens has a convex image-side surface in a paraxial region thereof, and the imaging lens system satisfies the conditional expression 4.0<(R3+R5)/R10<8.0, where R3 is a radius of curvature of an object-side surface of the second lens at the optical axis, R5 is a radius of curvature of an object-side surface of the third lens at the optical axis, and R10 is a radius of curvature of an image-side surface of the fifth lens at the optical axis.

The first lens may have a concave object-side surface in a paraxial region thereof.

The second lens may have a positive refractive power.

The second lens may have a convex object-side surface in a paraxial region thereof.

The third lens may have a convex object-side surface in a paraxial region thereof.

The fourth lens may have a concave object-side surface in a paraxial region thereof.

The fifth lens may have a negative refractive power.

The fifth lens may have a convex object-side surface in a paraxial region thereof.

The imaging lens system may satisfy the conditional expression −10.0<f1/f2<−1.0, where f1 is a focal length of the first lens, and f2 is a focal length of the second lens.

The imaging lens system may satisfy the conditional expression −3.0<f1/f3<2.0, where f1 is a focal length of the first lens, and f3 is a focal length of the third lens.

The imaging lens system may satisfy the conditional expression 2.0<f1/f5<20.0, where f1 is a focal length of the first lens, and f5 is a focal length of the fifth lens.

Other features and aspects will be apparent from the following detailed description, the drawings, and the claims.

### BRIEF DESCRIPTION OF DRAWINGS

FIG. 1 is a configuration diagram of an imaging lens system according to a first embodiment of the present disclosure.

FIG. 2 illustrates aberration curves of the imaging lens system illustrated in FIG. 1.

FIG. 3 is a configuration diagram of an imaging lens system according to a second embodiment of the present disclosure.

FIG. 4 illustrates aberration curves of the imaging lens system illustrated in FIG. 3.

FIG. 5 is a configuration diagram of an imaging lens system according to a third embodiment of the present disclosure.

FIG. 6 illustrates aberration curves of the imaging lens system illustrated in FIG. 5.

FIG. 7 is a configuration diagram of an imaging lens system according to a fourth embodiment of the present disclosure.

FIG. 8 illustrates aberration curves of the imaging lens system illustrated in FIG. 7.

FIG. 9 is a configuration diagram of an imaging lens system according to a fifth embodiment of the present disclosure.

FIG. 10 illustrates aberration curves of the imaging lens system illustrated in FIG. 9.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the present specification, a first lens refers to a lens most adjacent to an object (or a subject), and a fifth lens refers to a lens most adjacent to an imaging plane (or an image sensor). In the present specification, a radius of curvature of a lens surface, a thickness of a lens or other component, a distance between lenses or other components, TTL (a distance along an optical axis from an object-side surface of the first lens to the imaging plane), IMGHT (a height of the imaging plane), and a focal length are expressed in millimeters (mm), and FOV (a field of view of an imaging lens system) is expressed in degrees.

A thickness of a lens or other component, a distance between lenses or other components, and TTL are measured along the optical axis.

Also, in a description of a shape of a lens, a statement that a surface of the lens is convex means that a paraxial region of the surface is convex, and a statement that a surface of the lens is concave means that a paraxial region of the surface is concave.

Therefore, even when it is stated that a surface of a lens is convex, an edge portion of the surface may be concave. Similarly, even when it is stated that a surface of a lens is concave, an edge portion of the surface may be convex.

A paraxial region of a lens surface is a very narrow region of the lens surface near an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

An imaging lens system according to a first aspect of the present disclosure may include a plurality of lenses. For example, the imaging lens system according to the first aspect may include a first lens, a second lens, a third lens, a fourth lens, and a fifth lens sequentially disposed in ascending numerical order along an optical axis of the imaging lens system from an object side of the imaging lens system toward an imaging plane of the imaging lens system. An imaging lens system according to the first aspect may include a lens having a positive refractive power. For example, in the imaging lens system according to the first aspect, the second lens may have a positive refractive power. The imaging lens system according to the first aspect may include a lens made of a glass material and a lens made of a plastic material. For example, in the imaging lens system according to the first aspect, a lens disposed on an object side of a stop or an image side of the stop may be made of a glass material, and a rearmost lens of the imaging lens system may be made of a plastic material. As a specific example, in the imaging lens system according to the first aspect, the second lens may be made of a glass material, and the fifth lens may be made of a plastic material. The imaging lens system according to the first aspect may have an f-number less than 2.10.

An imaging lens system according to a second aspect of the present disclosure may include plurality of lenses. For example, an imaging lens system according to an aspect may include a first lens, a second lens, a third lens, a fourth lens, and a fifth lens sequentially disposed in ascending numerical order along an optical axis of the imaging lens system from an object side of the imaging lens system toward an imaging plane of the imaging lens system. The imaging lens system according to the second aspect may include a lens having a negative refractive power. For example, in an imaging lens system according to the second aspect, the first lens may have a negative refractive power. The imaging lens system according to the second aspect may include a lens having a convex image-side surface. For example, in the imaging lens system according to the second aspect, either one or both of an image-side surface of the first lens and an image-side surface of the third lens may have a convex shape. The imaging lens system according to the second aspect may satisfy a specific conditional expression. For example, the imaging lens system according to the second aspect may satisfy the conditional expression 4.0<(R3+R5)/R10<8.0, where R3 is a radius of curvature of the object-side surface of the second lens at the optical axis, R5 is a radius of curvature of the object-side surface of the third lens at the optical axis, and R10 is a radius of curvature of the image-side surface of the fifth lens at the optical axis.

An imaging lens system according to a third aspect of the present disclosure may include a plurality of lenses. For example, an imaging lens system according to the third aspect may include a first lens, a second lens, a third lens, a fourth lens, and a fifth lens sequentially disposed in ascending numerical order along an optical axis of the imaging lens system from an object side of the imaging lens system toward an imaging plane of the imaging lens system. The imaging lens system according to the third aspect may include a stop. For example, the imaging lens system according to the third aspect may include a stop disposed on the object side of the first lens or between the first lens and the second lens. The imaging lens system according to the third aspect may include a lens made of a glass material and a lens made of a plastic material. For example, in the imaging lens system according to the third aspect, the second lens may be made of a glass material, and the fifth lens may be made of a plastic material.

An imaging lens system according to the fourth aspect of the present disclosure may include first to fifth lenses sequentially disposed in ascending numerical order along an optical axis of the imaging lens system from an object side of the imaging lens system toward an imaging plane of the imaging lens system, and may satisfy any one or any combination of any two or more of the following conditional expressions:

$$f - number < 2.1 \qquad ( Conditional Expression 1 )$$

$$- 0.8 < f / f 4 < 2. \qquad ( Conditional Expression 2 )$$

$$- 10 < f 1 / f 2 < - 1. \qquad ( Conditional Expression 3 )$$

$$- 3. < f 1 / f 3 < 2. \qquad ( Conditional Expression 4 )$$

$$- 3. < f 1 / f 4 < 2. \qquad ( Conditional Expression 5 )$$

$$2. < f 1 / f 5 < 20 \qquad ( Conditional Expression 6 )$$

$$- 0.4 < f 2 / f 4 < 2.4 \qquad ( Conditional Expression 7 )$$

$$- 12 < f 3 / f 4 < 2. \qquad ( Conditional Expression 8 )$$

In the above conditional expressions, f-number is an f-number of the imaging lens system, f is a focal length of the imaging lens system, f1 is a focal length of the first lens, f2 is a focal length of the second lens, f3 is a focal length of the third lens, f4 is a focal length of the fourth lens, and f5 is a focal length of the fifth lens.

An imaging lens system according to a fifth aspect of the present disclosure may include first to fifth lenses sequentially disposed in ascending numerical order along an optical axis of the imaging lens system from an object side of the imaging lens system toward an imaging plane of the imaging lens system, and may satisfy any one or any combination of any two or more of the following conditional expressions:

$$4. < ( R 3 + R 5 ) / R 10 < 8. \qquad ( Conditional Expression 9 )$$

$$0 < ( R 5 + R 9 ) / R 10 < 10 \qquad ( Conditional Expression 10 )$$

$$1.2 < ( R 3 + R 9 + R 10 ) / f 2 < 3.2 \qquad ( Conditional Expression 11 )$$

$$1. < Nd 2 / Nd 5 < 1.4 \qquad ( Conditional Expression 12 )$$

$$8. < \vert V 5 - V 2 \vert < 30 \qquad ( Conditional Expression 13 )$$

In the above conditional expressions, R3 is a radius of curvature of an object-side surface of the second lens at the optical axis, R5 is a radius of curvature of an object-side surface of the third lens at the optical axis, R9 is a radius of curvature of an object-side surface of the fifth lens at the optical axis, R10 is a radius of curvature of an image-side surface of the fifth lens at the optical axis, Nd2 is a refractive index of the second lens, Nd5 is a refractive index of the fifth lens, V2 is an Abbe number of the second lens, and V5 is an Abbe number of the fifth lens.

An imaging lens system according to a sixth aspect of the present disclosure may include any combination of any two or more of the first to fifth lenses having the characteristics described below. For example, the imaging lens system according to the sixth aspect may include the characteristics of the first aspect, and may satisfy any one or any combination of any two or more of the conditional expressions according to the fourth aspect. As another example, the imaging lens system according to the sixth aspect may include characteristics of the second aspect, and may satisfy any one or any combination of any two or more or more of the conditional expressions according to the fifth aspect.

The imaging lens system according to the first to sixth aspects may include any one or any combination of any two or more of the first to fifth lenses having the characteristics described below. As an example, the imaging lens system according to the first aspect may include one of the first to fifth lenses having the characteristics described below. As another example, the imaging lens system according to the second aspect may include any combination of any two or more of the first to fifth lenses having the characteristics described below. However, the imaging lens system according to the above-described aspects does not necessarily include a lens having the characteristics described below. Characteristics of the first to fifth lenses are described below.

The first lens may have a refractive power. For example, the first lens may have a negative refractive power. The first lens may have a concave shape on at least one surface. For example, the first lens may have a concave object-side surface, or a concave object-side surface and a concave image-side surface. The first lens may include a spherical surface or an aspherical surface. For example, both surfaces of the first lens may be aspherical. The first lens may be made of a material having a high light transmittance and an excellent processability. For example, the first lens may be made of a plastic material. The first lens may have a predetermined refractive index. For example, the first lens may have a refractive index of 1.52 or greater. The first lens may have a predetermined Abbe number. For example, the first lens may have an Abbe number of 20 or greater.

The second lens may have a refractive power. For example, the second lens may have a positive refractive power. The second lens may have a convex shape on at least one surface. For example, the second lens may have a convex object-side surface, or a convex object-side surface and convex image-side surface. The second lens may include a spherical surface. For example, both surfaces of the second lens may be spherical. The second lens may be made of a material having a high light transmittance and an excellent processability. For example, the second lens may be made of a glass material. The second lens may have a predetermined refractive index. For example, a refractive index of the second lens may be 1.56 or greater. The second lens may have a predetermined Abbe number. For example, the second lens may have an Abbe number of 30 or greater.

The third lens may have a refractive power. For example, the third lens may have a positive refractive power or a negative refractive power. The third lens may have a convex shape on at least one surface. For example, the third lens may have a convex object-side surface, or a convex object-side surface and a convex image-side surface. The third lens may include a spherical surface or an aspherical surface. For example, both surfaces of the third lens may be aspherical. The third lens may be made of a material having a high light transmittance and an excellent processability. For example, the third lens may be made of a plastic material. The third lens may have a predetermined refractive index. For example, a refractive index of the third lens may be 1.52 or more. The third lens may have a predetermined Abbe number. For example, the third lens may have an Abbe number of 58 or greater.

The fourth lens may have a refractive power. For example, the fourth lens may have a positive refractive power or a negative refractive power. The fourth lens may have a concave shape on one surface. For example, the fourth lens may have a concave object-side surface. As another example, the fourth lens may have a convex shape on at least one surface. For example, the fourth lens may have a convex image-side surface, or a convex object-side surface and a convex image-side surface. The fourth lens may include a spherical surface or an aspherical surface. For example, both surfaces of the fourth lens may be aspherical. The fourth lens may be made of a material having a high light transmittance and an excellent processability. For example, the fourth lens may be made of a plastic material. The fourth lens may have a predetermined refractive index. For example, a refractive index of the fourth lens may be 1.52 or greater. The fourth lens may have a predetermined Abbe number. For example, the fourth lens may have an Abbe number of 20 or greater.

The fifth lens may have a refractive power. For example, the fifth lens may have a negative refractive power. The fifth lens may have a convex shape on one surface. For example, the fifth lens may have a convex object-side surface. As another example, the fifth lens may have a concave shape on at least one surface. For example, the fifth lens may have a concave image-side surface, or a concave object-side surface and a concave image-side surface. The fifth lens may include a spherical surface or an aspherical surface. For example, both surfaces of the fifth lens may be aspherical. The fifth lens may be made of a material having a high light transmittance and an excellent processability. For example, the fifth lens may be made of a plastic material. The fifth lens may have a predetermined refractive index. For example, a refractive index of the fifth lens may be 1.52 or greater. The fifth lens may have a predetermined Abbe number. For example, the fifth lens may have an Abbe number of 20 or greater.

An aspherical surface of a lens of the imaging lens system may be defined by the following Equation 1:

$$Z = \frac{{cr}^{2}}{1 + \sqrt{1 - ( 1 - k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} + {Jr}^{20} \qquad ( 1 )$$

In Equation 1, c is a curvature of the lens surface and is equal to a reciprocal of a radius of curvature of the lens surface at an optical axis of the lens surface, k is a conic constant, and r is a distance from any point on the aspherical surface of the lens to the optical axis. In addition, constants A to H and J are aspherical surface coefficients. Z (also known as sag) is a distance in a direction parallel to an optical axis direction between the point on the aspherical surface of the lens at the distance r from the optical axis of the aspherical surface to a tangential plane perpendicular to the optical axis and intersecting a vertex of the aspherical surface.

The imaging lens system may include a stop, an imaging plane, a filter, and a cover glass.

The stop may be disposed between two lenses. For example, the stop may be disposed between the first lens and the second lens. As another example, the stop may be disposed on an object side of a lens made of a glass material and having a positive refractive power. As another example, the stop may be disposed on an object side of the first lens. The imaging plane may be formed at a point at which light refracted by the first to fifth lenses forms an image. The imaging plane may be formed by an image sensor. For example, the imaging plane may be formed on a surface of the image sensor or on an internal layer of the image sensor. The filter may be disposed between the fifth lens and the imaging plane. The filter may block certain wavelengths of light. For example, the filter may block light in infrared wavelengths. The cover glass may be disposed between the filter and the imaging plane. The cover glass may be configured to block foreign substances from contaminating a surface of the imaging plane (or image sensor).

Hereinafter, embodiments of the present disclosure will be described in detail with reference to the drawings.

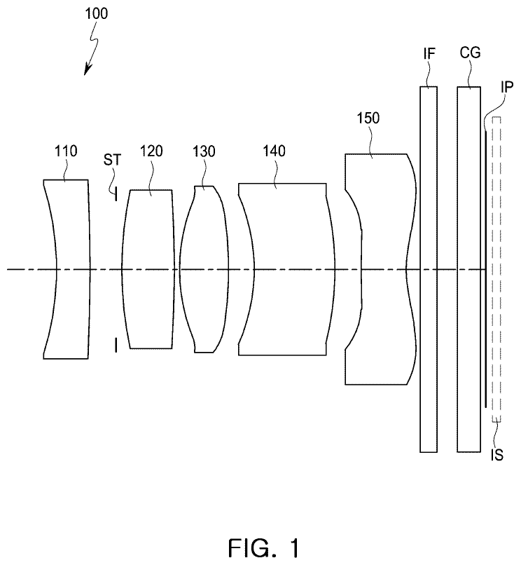

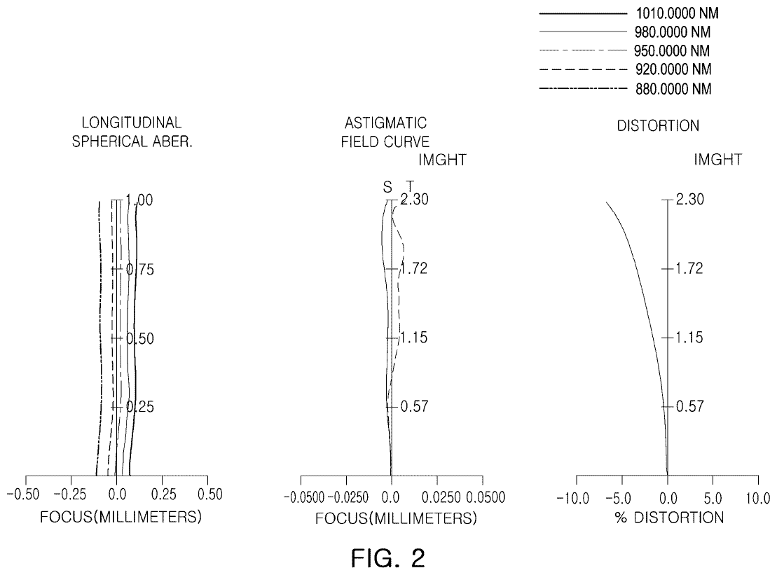

FIG. 1 is a configuration diagram of an imaging lens system according to a first embodiment of the present disclosure. FIG. 2 illustrates aberration curves of the imaging lens system illustrated in FIG. 1.

Referring to FIG. 1, an imaging lens system 100 may include a first lens 110, a second lens 120, a third lens 130, a fourth lens 140, and a fifth lens 150.

The first lens 110 may have a negative refractive power, and may have a concave object-side surface and a convex image-side surface. The second lens 120 may have a positive refractive power, and may have a convex object-side surface and a convex image-side surface. The third lens 130 may have a positive refractive power, and may have a convex object-side surface and a convex image-side surface. The fourth lens 140 may have a negative refractive power, and may have a concave object-side surface and a convex image-side surface. The fifth lens 150 may have a negative refractive power, and may have a convex object-side surface and a concave image-side surface.

The imaging lens system 100 may further include a stop ST, a filter IF, a cover glass CG, and an imaging plane IP. The stop ST may be disposed between the first lens 110 and the second lens 120. The imaging plane IP may be formed on an image sensor IS, and the filter IF and the cover glass CG may be disposed between the fifth lens 150 and the imaging plane IP.

Tables 1 and 2 below illustrate lens characteristics and aspherical values of the imaging lens system 100.

TABLE 1

| | | | | Effec- | Refrac- | |
|---|---|---|---|---|---|---|
| Surface | | Radius of | Thickness/ | tive | tive | Abbe |
| No. | Component | Curvature | Distance | Radius | Index | No. |
| S0 | Object | Infinity | 580 | | | |
| S1 | 1st Lens | −6.7397 | 0.6000 | 1.4576 | 1.536 | 60.40 |
| S2 | | −500.0000 | 0.4790 | 1.3307 | | |
| S3 | Stop | Infinity | 0.1000 | 1.2268 | | |
| S4 | 2nd Lens | 6.9485 | 0.9441 | 1.2781 | 1.954 | 32.32 |
| S5 | | −23.1415 | 0.1000 | 1.3000 | | |
| S6 | 3rd Lens | 2.8421 | 0.8682 | 1.3182 | 1.536 | 60.40 |
| S7 | | −35.8351 | 0.4580 | 1.3497 | | |
| S8 | 4th Lens | −4.0572 | 1.4605 | 1.2908 | 1.656 | 20.97 |
| S9 | | −6.1402 | 0.4766 | 1.3999 | | |
| S10 | 5th Lens | 4.9937 | 0.7953 | 1.4498 | 1.536 | 60.40 |
| S11 | | 1.8295 | 0.2570 | 1.8938 | | |
| S12 | Filter | Infinity | 0.3000 | 3.0000 | 1.517 | 64.17 |
| S13 | | Infinity | 0.3750 | 3.0000 | | |
| S14 | Cover | Infinity | 0.4000 | 3.0000 | 1.517 | 64.17 |
| S15 | Glass | Infinity | 0.1000 | 3.0000 | | |
| S16 | Imaging | Infinity | 0.0000 | 2.3000 | | |
| | Plane | | | | | |

TABLE 2

| Surface | | | | |
|---|---|---|---|---|
| No. | S1 | S2 | S6 | S7 |
| k | 4.426E+00 | 9.000E+01 | −2.002E+00 | 8.300E+01 |
| A | −2.187E−02 | −2.530E−02 | −9.844E−03 | −6.391E−02 |
| B | 9.571E−03 | 1.257E−02 | 8.019E−03 | 1.501E−02 |
| C | −2.055E−03 | −2.158E−03 | −1.469E−02 | −8.152E−03 |
| D | 3.979E−04 | −5.523E−04 | 1.546E−02 | 8.517E−03 |
| E | −4.937E−05 | 8.626E−04 | −1.089E−02 | −5.118E−03 |
| F | 0.000E+00 | −3.612E−04 | 4.225E−03 | 1.324E−03 |
| G | 0.000E+00 | 5.375E−05 | −7.493E−04 | −1.669E−04 |
| H | 0.000E+00 | 0.000E+00 | 0.000E+00 | 0.000E+00 |
| J | 0.000E+00 | 0.000E+00 | 0.000E+00 | 0.000E+00 |
| Surface | | | | |
| No. | S8 | S9 | S10 | S11 |
| k | −2.737E+01 | −2.058E+00 | 2.093E−01 | −5.844E+00 |
| A | −1.114E−01 | −9.296E−02 | −2.703E−01 | −1.178E−01 |
| B | 6.787E−02 | 1.173E−01 | 1.444E−01 | 7.563E−02 |
| C | −3.309E−02 | −9.993E−02 | −4.808E−02 | −3.715E−02 |
| D | 2.746E−02 | 7.716E−02 | 1.008E−02 | 1.332E−02 |
| E | −1.713E−02 | −3.863E−02 | −1.464E−03 | −3.244E−03 |
| F | 5.097E−03 | 1.064E−02 | 0.000E+00 | 4.537E−04 |
| G | −5.518E−04 | −1.249E−03 | 0.000E+00 | −2.709E−05 |
| H | 0.000E+00 | 0.000E+00 | 0.000E+00 | 0.000E+00 |
| J | 0.000E+00 | 0.000E+00 | 0.000E+00 | 0.000E+00 |

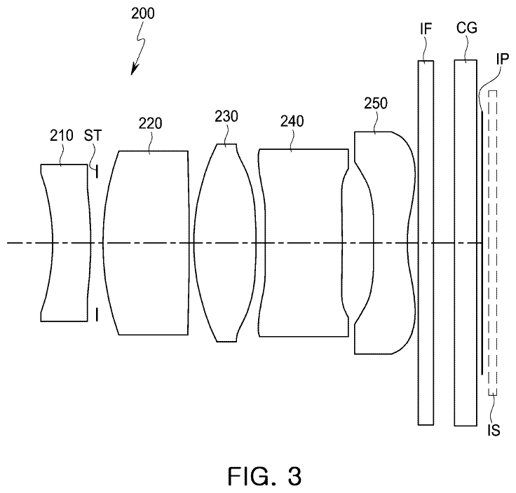

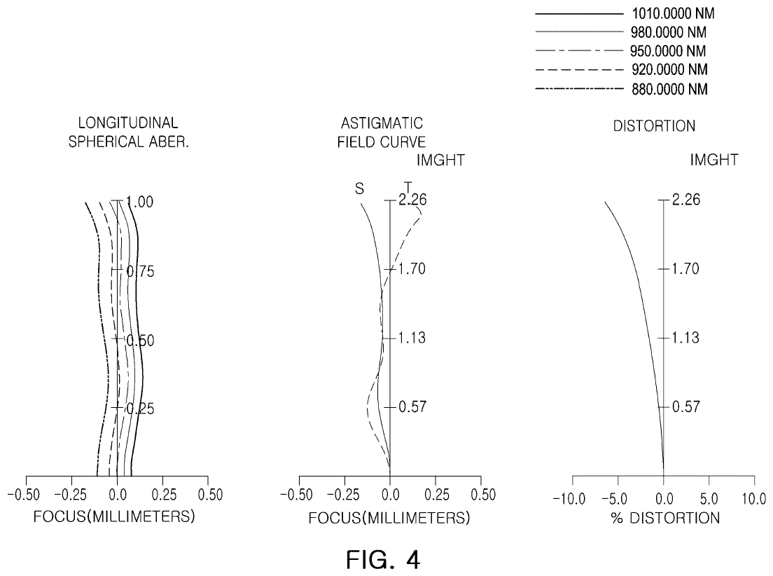

FIG. 3 is a configuration diagram of an imaging lens system according to a second embodiment of the present disclosure. FIG. 4 illustrates aberration curves of the imaging lens system illustrated in FIG. 3.

Referring to FIG. 3, an imaging lens system 200 may include a first lens 210, a second lens 220, a third lens 230, a fourth lens 240, and a fifth lens 250.

The first lens 210 may have a negative refractive power, and may have a concave object-side surface and a convex image-side surface. The second lens 220 may have a positive refractive power, and may have a convex object-side surface and a convex image-side surface. The third lens 230 may have a positive refractive power, and may have a convex object-side surface and a concave image-side surface. The fourth lens 240 may have a positive refractive power, and may have a convex object-side surface and a convex image-side surface. The fifth lens 250 may have a negative refractive power, and may have a convex object-side surface and a concave image-side surface.

The imaging lens system 200 may further include a stop ST, a filter IF, a cover glass CG, and an imaging plane IP. The stop ST may be disposed between the first lens 210 and the second lens 220. The imaging plane IP may be formed on an image sensor IS, and the filter IF and the cover glass CG may be disposed between the fifth lens 250 and the imaging plane IP.

Tables 3 and 4 below illustrate lens characteristics and aspherical values of the imaging lens system 200.

TABLE 3

| | | | | Effec- | Refrac- | |
|---|---|---|---|---|---|---|
| Surface | | Radius of | Thickness/ | tive | tive | Abbe |
| No. | Component | Curvature | Distance | Radius | Index | No. |
| S0 | Object | Infinity | 580 | | | |
| S1 | 1st Lens | −3.1201 | 0.6907 | 1.2850 | 1.536 | 60.40 |
| S2 | | −6.1924 | 0.1000 | 1.2286 | | |
| S3 | Stop | Infinity | 0.1000 | 1.2142 | | |
| S4 | 2nd Lens | 4.9261 | 1.5597 | 1.3880 | 1.804 | 46.50 |
| S5 | | −62.4198 | 0.1000 | 1.5669 | | |
| S6 | 3rd Lens | 3.4108 | 1.1127 | 1.6676 | 1.536 | 60.40 |
| S7 | | 13.9387 | 0.1624 | 1.6599 | | |
| S8 | 4th Lens | 10.8456 | 1.3885 | 1.5887 | 1.536 | 60.40 |
| S9 | | −171.5037 | 0.5665 | 1.3435 | | |
| S10 | 5th Lens | 6.7797 | 0.6000 | 1.4089 | 1.536 | 60.40 |
| S11 | | 1.7286 | 0.1945 | 1.8580 | | |
| S12 | Filter | Infinity | 0.3000 | 3.0000 | 1.517 | 64.17 |
| S13 | | Infinity | 0.3750 | 3.0000 | | |
| S14 | Cover | Infinity | 0.4000 | 3.0000 | 1.517 | 64.17 |
| S15 | Glass | Infinity | 0.1000 | 3.0000 | | |
| S16 | Imaging | Infinity | 0.0000 | 2.2645 | | |
| | Plane | | | | | |

TABLE 4

| Surface | | | | |
|---|---|---|---|---|
| No. | S1 | S2 | S6 | S7 |
| k | −2.741E+00 | −8.822E+00 | −1.751E+00 | 6.321E+01 |
| A | 6.805E−03 | 1.319E−02 | −1.239E−02 | −1.855E−01 |
| B | 3.384E−03 | 3.795E−03 | 1.225E−02 | 7.373E−02 |
| C | −5.584E−04 | 1.375E−04 | −1.363E−02 | −5.996E−03 |
| D | 0.000E+00 | 0.000E+00 | 8.095E−03 | −5.539E−03 |
| E | 0.000E+00 | 0.000E+00 | −2.875E−03 | 1.768E−03 |
| F | 0.000E+00 | 0.000E+00 | 5.427E−04 | −1.463E−04 |
| G | 0.000E+00 | 0.000E+00 | −3.434E−05 | 0.000E+00 |
| H | 0.000E+00 | 0.000E+00 | 0.000E+00 | 0.000E+00 |
| J | 0.000E+00 | 0.000E+00 | 0.000E+00 | 0.000E+00 |
| Surface | | | | |
| No. | S8 | S9 | S10 | S11 |
| k | −4.446E−01 | 9.000E+01 | 1.274E+01 | −8.092E+00 |
| A | −1.648E−01 | −4.999E−02 | −2.821E−01 | −1.167E−01 |
| B | 5.384E−02 | 1.153E−01 | 1.749E−01 | 7.501E−02 |
| C | 3.213E−02 | −1.347E−01 | −8.151E−02 | −3.882E−02 |
| D | −2.815E−02 | 1.403E−01 | 2.302E−02 | 1.433E−02 |
| E | 7.971E−03 | −8.867E−02 | −2.912E−03 | −3.796E−03 |
| F | −8.113E−04 | 3.052E−02 | 0.000E+00 | 6.310E−04 |
| G | 0.000E+00 | −4.307E−03 | 0.000E+00 | −4.947E−05 |
| H | 0.000E+00 | 0.000E+00 | 0.000E+00 | 0.000E+00 |
| J | 0.000E+00 | 0.000E+00 | 0.000E+00 | 0.000E+00 |

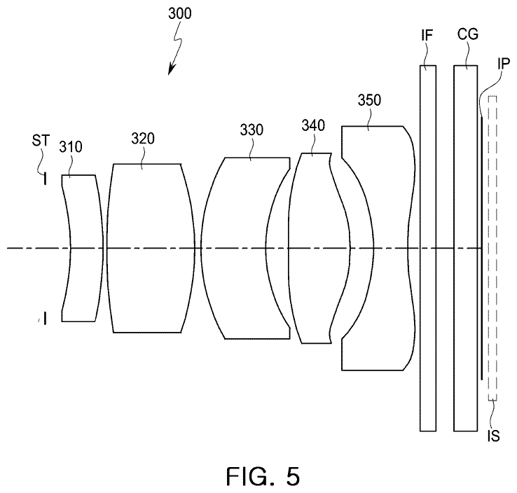

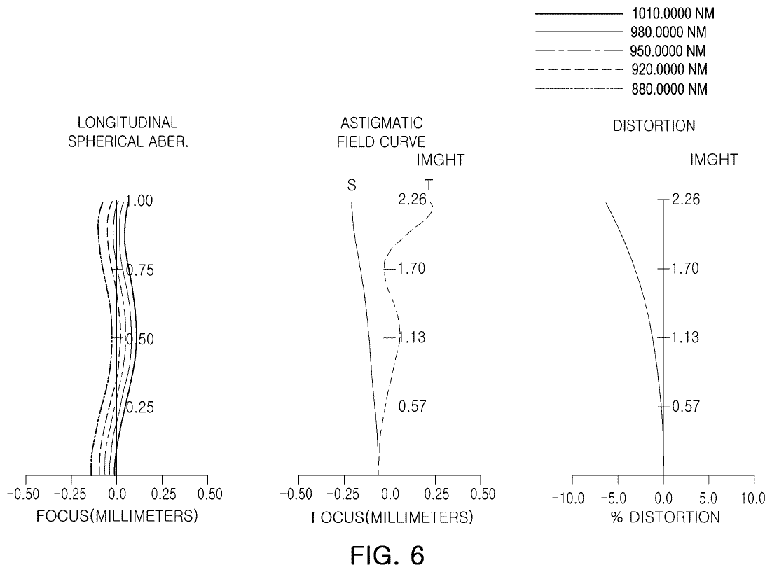

FIG. 5 is a configuration diagram of an imaging lens system according to a third embodiment of the present disclosure. FIG. 6 illustrates aberration curves of the imaging lens system illustrated in FIG. 5.

Referring to FIG. 5, an imaging lens system 300 may include a first lens 310, a second lens 320, a third lens 330, a fourth lens 340, and a fifth lens 350.

The first lens 310 may have a negative refractive power, and may have a concave object-side surface and a convex image-side surface. The second lens 320 may have a positive refractive power, and may have a convex object-side surface and a convex image-side surface. The third lens 330 may have a negative refractive power, and may have a convex object-side surface and a concave image-side surface. The fourth lens 340 may have a positive refractive power, and may have a convex object-side surface and a convex image-side surface. The fifth lens 350 may have a negative refractive power, and may have a concave object-side surface and a concave image-side surface.

The imaging lens system 300 may further include a stop ST, a filter IF, a cover glass CG, and an imaging plane IP. The stop ST may be disposed on an object side of the first lens 310. The imaging plane IP may be formed on an image sensor IS, and the filter IF and the cover glass CG may be disposed between the fifth lens 350 and the imaging plane IP.

Tables 5 and 6 below illustrate lens characteristics and aspherical values of the imaging lens system 300.

TABLE 5

| | | | | Effec- | Refrac- | |
|---|---|---|---|---|---|---|
| Surface | | Radius of | Thickness/ | tive | tive | Abbe |
| No. | Component | Curvature | Distance | Radius | Index | No. |
| S0 | Object | Infinity | 600 | | | |
| S1 | 1st Lens | −6.6561 | 0.6028 | 1.1247 | 1.536 | 60.40 |
| S2 | | −9.1069 | 0.0500 | 1.2323 | | |
| S3 | 2nd Lens | 9.8607 | 1.6017 | 1.2802 | 1.593 | 68.62 |
| S4 | | −4.7881 | 0.1000 | 1.3877 | | |
| S5 | 3rd Lens | 2.7834 | 1.1723 | 1.4844 | 1.536 | 60.40 |
| S6 | | 2.0769 | 0.4015 | 1.4631 | | |
| S7 | 4th Lens | 15.2561 | 1.1368 | 1.4952 | 1.536 | 60.40 |
| S8 | | −1.7840 | 0.4116 | 1.5680 | | |
| S9 | 5th Lens | −2.7821 | 0.6000 | 1.5613 | 1.536 | 60.40 |
| S10 | | 3.0165 | 0.2396 | 2.0126 | | |
| S11 | Filter | Infinity | 0.3000 | 3.0000 | 1.517 | 64.17 |
| S12 | | Infinity | 0.3750 | 3.0000 | | |
| S13 | Cover | Infinity | 0.4000 | 3.0000 | 1.517 | 64.17 |
| S14 | Glass | Infinity | 0.0929 | 3.0000 | | |
| S15 | Imaging | Infinity | 0.0071 | 2.2691 | | |
| | Plane | | | | | |

TABLE 6

| Surface | | | | |
|---|---|---|---|---|
| No. | S1 | S2 | S5 | S6 |
| k | −3.103E+01 | 1.747E+00 | −5.109E−01 | −6.930E−01 |
| A | 1.062E−02 | −3.590E−02 | −2.340E−02 | −2.314E−02 |
| B | 5.622E−03 | 1.238E−02 | 4.932E−03 | −1.998E−03 |
| C | −4.065E−03 | −1.466E−03 | −3.790E−04 | 4.355E−03 |
| D | 1.668E−03 | 2.378E−04 | 9.572E−05 | −2.161E−03 |
| E | −2.888E−04 | 0.000E+00 | 0.000E+00 | 4.259E−04 |
| F | 0.000E+00 | 0.000E+00 | 0.000E+00 | 0.000E+00 |
| G | 0.000E+00 | 0.000E+00 | 0.000E+00 | 0.000E+00 |
| H | 0.000E+00 | 0.000E+00 | 0.000E+00 | 0.000E+00 |
| J | 0.000E+00 | 0.000E+00 | 0.000E+00 | 0.000E+00 |
| Surface | | | | |
| No. | S7 | S8 | S9 | S10 |
| k | −2.451E+00 | −3.870E+00 | −1.000E+01 | −9.778E−01 |
| A | 1.318E−02 | 1.651E−02 | −2.475E−02 | −7.298E−02 |
| B | −1.041E−03 | −9.798E−03 | −1.931E−02 | 2.134E−02 |
| C | 7.967E−04 | 4.251E−03 | 9.692E−03 | −6.982E−03 |
| D | 0.000E+00 | 0.000E+00 | −1.597E−03 | 1.718E−03 |
| E | 0.000E+00 | 0.000E+00 | 4.049E−05 | −2.459E−04 |
| F | 0.000E+00 | 0.000E+00 | 0.000E+00 | 1.385E−05 |
| G | 0.000E+00 | 0.000E+00 | 0.000E+00 | 0.000E+00 |
| H | 0.000E+00 | 0.000E+00 | 0.000E+00 | 0.000E+00 |
| J | 0.000E+00 | 0.000E+00 | 0.000E+00 | 0.000E+00 |

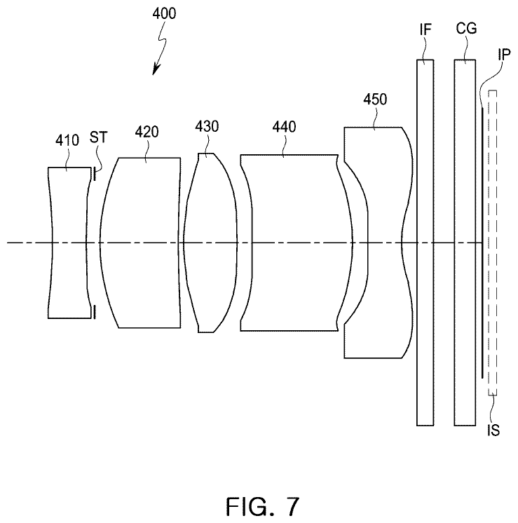

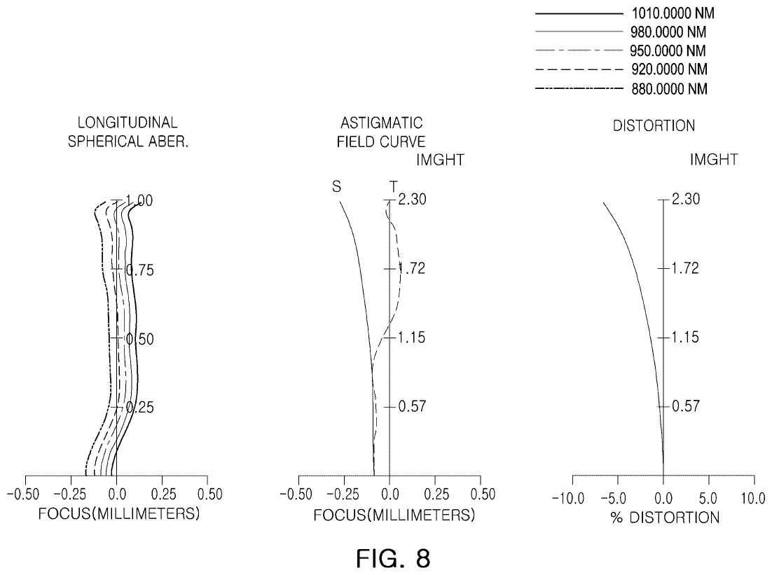

FIG. 7 is a configuration diagram of an imaging lens system according to a fourth embodiment of the present disclosure. FIG. 8 illustrates aberration curves of the imaging lens system illustrated in FIG. 7.

Referring to FIG. 7, an imaging lens system 400 may include a first lens 410, a second lens 420, a third lens 430, a fourth lens 440, and a fifth lens 450.

The first lens 410 may have a negative refractive power, and may have a concave object-side surface and a concave image-side surface. The second lens 420 may have a positive refractive power, and may have a convex object-side surface and a concave image-side surface. The third lens 430 may have a positive refractive power, and may have a convex object-side surface and a convex image-side surface. The fourth lens 440 may have a positive refractive power, and may have a concave object-side surface and a convex image-side surface. The fifth lens 450 may have a negative refractive power, and may have a convex object-side surface and a concave image-side surface.

The imaging lens system 400 may further include a stop ST, a filter IF, a cover glass CG, and an imaging plane IP. The stop ST may be disposed between the first lens 410 and the second lens 420. The imaging plane IP may be formed on an image sensor IS, the filter IF and the cover glass CG may be disposed between the fifth lens 450 and the imaging plane IP.

Tables 7 and 8 below illustrate lens characteristics and aspherical values of the imaging lens system 400.

TABLE 7

| | | | | Effec- | Refrac- | |
|---|---|---|---|---|---|---|
| Surface | | Radius of | Thickness/ | tive | tive | Abbe |
| No. | Component | Curvature | Distance | Radius | Index | No. |
| S0 | Object | infinity | 580 | | | |
| S1 | 1st Lens | −6.0941 | 0.6175 | 1.2457 | 1.536 | 60.40 |
| S2 | | 500.0000 | 0.1534 | 1.1388 | | |
| S3 | Stop | infinity | 0.1000 | 1.1469 | | |
| S4 | 2nd Lens | 3.8042 | 1.4020 | 1.3143 | 1.773 | 49.62 |
| S5 | | 22.1376 | 0.1000 | 1.4051 | | |
| S6 | 3rd Lens | 4.2775 | 0.9625 | 1.4608 | 1.536 | 60.40 |
| S7 | | −15.8219 | 0.2837 | 1.4777 | | |
| S8 | 4th Lens | −500.0000 | 1.8000 | 1.3755 | 1.536 | 60.40 |
| S9 | | −3.5840 | 0.2743 | 1.4543 | | |
| S10 | 5th Lens | 5.3059 | 0.6000 | 1.4732 | 1.656 | 20.97 |
| S11 | | 1.3357 | 0.2816 | 1.9039 | | |
| S12 | Filter | infinity | 0.3000 | 3.0000 | 1.517 | 64.17 |
| S13 | | infinity | 0.3750 | 3.0000 | | |
| S14 | Cover | infinity | 0.4000 | 3.0000 | 1.517 | 64.17 |
| S15 | Glass | infinity | 0.1000 | 3.0000 | | |
| S16 | Imaging | infinity | 0.0000 | 2.3009 | | |
| | Plane | | | | | |

TABLE 8

| Surface | | | | |
|---|---|---|---|---|
| No. | S1 | S2 | S6 | S7 |
| k | −3.103E+01 | 9.000E+01 | 1.221E+00 | −9.000E+01 |
| A | 1.062E−02 | 4.437E−02 | 1.004E−04 | −6.978E−02 |
| B | 5.622E−03 | −2.570E−02 | 4.352E−03 | 2.624E−03 |
| C | −4.065E−03 | 7.928E−02 | −8.914E−03 | 5.183E−03 |
| D | 1.668E−03 | −1.277E−01 | 8.732E−03 | −2.657E−03 |
| E | −2.888E−04 | 1.162E−01 | −5.990E−03 | 1.128E−03 |
| F | 0.000E+00 | −5.532E−02 | 2.280E−03 | −1.976E−04 |
| G | 0.000E+00 | 1.078E−02 | −3.646E−04 | −1.920E−05 |
| H | 0.000E+00 | 0.000E+00 | 0.000E+00 | 0.000E+00 |
| J | 0.000E+00 | 0.000E+00 | 0.000E+00 | 0.000E+00 |
| Surface | | | | |
| No. | S8 | S9 | S10 | S11 |
| k | 9.000E+01 | 1.356E+00 | 4.605E+00 | −7.437E+00 |
| A | −6.581E−02 | −1.247E−01 | −4.406E−01 | −1.268E−01 |
| B | −1.251E−02 | 2.051E−01 | 3.993E−01 | 9.543E−02 |
| C | 2.183E−02 | −1.879E−01 | −2.595E−01 | −4.978E−02 |
| D | −1.951E−02 | 1.165E−01 | 1.060E−01 | 1.634E−02 |
| E | 1.466E−02 | −4.522E−02 | −2.481E−02 | −3.306E−03 |
| F | −5.450E−03 | 1.004E−02 | 2.571E−03 | 3.736E−04 |
| G | 7.414E−04 | −9.252E−04 | 0.000E+00 | −1.806E−05 |
| H | 0.000E+00 | 0.000E+00 | 0.000E+00 | 0.000E+00 |
| J | 0.000E+00 | 0.000E+00 | 0.000E+00 | 0.000E+00 |

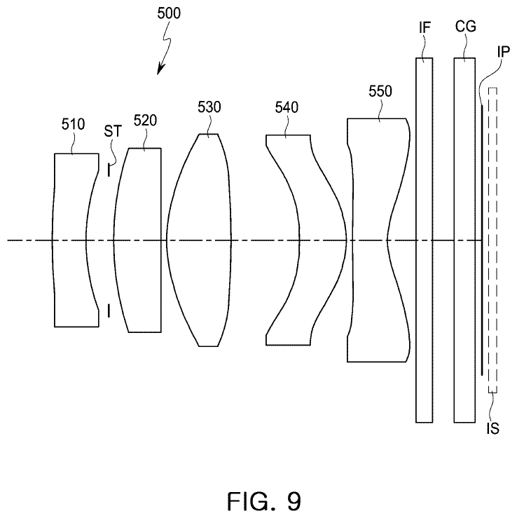

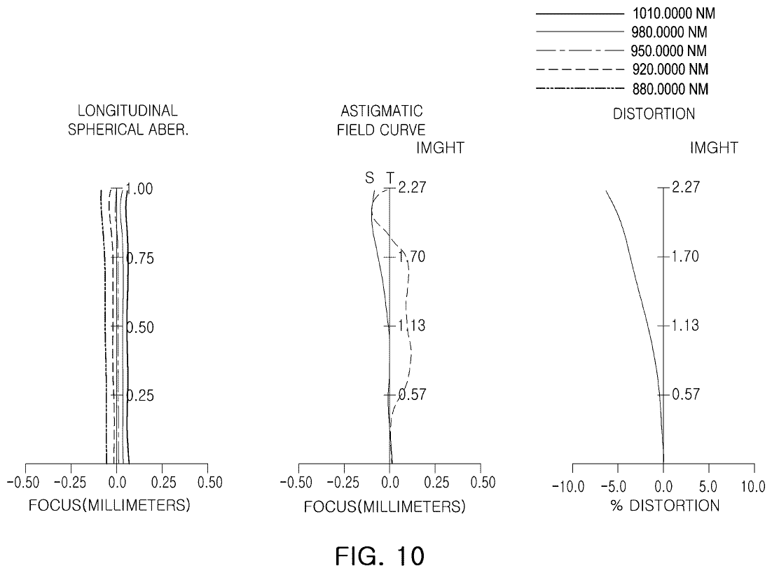

FIG. 9 is a configuration diagram of an imaging lens system according to a fifth embodiment of the present disclosure. FIG. 10 illustrates aberration curves of the imaging lens system illustrated in FIG. 9.

Referring to FIG. 9, an imaging lens system 500 may include a first lens 510, a second lens 520, a third lens 530, a fourth lens 540, and a fifth lens 550.

The first lens 510 may have a negative refractive power, and may have a convex object-side surface and a concave image-side surface. The second lens 520 may have a positive refractive power, and may have a convex object-side surface and a convex image-side surface. The third lens 530 may have a positive refractive power, and may have a convex object-side surface and a convex image-side surface. The fourth lens 540 may have a positive refractive power, and may have a concave object-side surface and a convex image-side surface. The fifth lens 550 may have a negative refractive power, and may have a convex object-side surface and a concave image-side surface.

The imaging lens system 500 may further include a stop ST, a filter IF, a cover glass CG, and an imaging plane IP. The stop ST may be disposed between the first lens 510 and the second lens 520. The imaging plane IP may be formed on an image sensor IS, the filter IF and the cover glass CG may be disposed between the fifth lens 550 and the imaging plane IP.

Tables 9 and 10 below illustrate lens characteristics and aspherical values of the imaging lens system 500.

TABLE 9

| | | | | Effec- | Refrac- | |
|---|---|---|---|---|---|---|
| Surface | | Radius of | Thickness/ | tive | tive | Abbe |
| No. | Component | Curvature | Distance | Radius | Index | No. |
| S0 | Object | Infinity | 600 | | | |
| S1 | 1st Lens | 5.5382 | 0.6000 | 1.4297 | 1.656 | 20.97 |
| S2 | | 2.3279 | 0.4260 | 1.2166 | | |
| S3 | Stop | Infinity | 0.1000 | 1.1644 | | |
| S4 | 2nd Lens | 5.6889 | 0.8419 | 1.3943 | 1.954 | 32.32 |
| S5 | | −256.0391 | 0.1000 | 1.5180 | | |
| S6 | 3rd Lens | 2.8586 | 1.1647 | 1.7332 | 1.536 | 60.40 |
| S7 | | −30.2947 | 1.2413 | 1.7554 | | |
| S8 | 4th Lens | −2.9532 | 0.8479 | 1.6499 | 1.536 | 60.40 |
| S9 | | −1.2888 | 0.1000 | 1.7288 | | |
| S10 | 5th Lens | 9.1887 | 0.6282 | 1.7769 | 1.536 | 60.40 |
| S11 | | 1.2354 | 0.5250 | 2.0073 | | |
| S12 | Filter | Infinity | 0.3000 | 3.0000 | 1.517 | 64.17 |
| S13 | | Infinity | 0.3750 | 3.0000 | | |
| S14 | Cover | Infinity | 0.4000 | 3.0000 | 1.517 | 64.17 |
| S15 | Glass | Infinity | 0.1000 | 3.0000 | | |
| S16 | Imaging | Infinity | 0.0000 | 2.2650 | | |
| | Plane | | | | | |

TABLE 10

| Surface | | | | |
|---|---|---|---|---|
| No. | S1 | S2 | S6 | S7 |
| k | −2.298E+01 | −2.405E+00 | 8.850E−01 | −1.209E+01 |
| A | −3.155E−02 | −4.646E−02 | −1.167E−02 | −5.973E−03 |
| B | 2.969E−03 | 1.403E−02 | −2.342E−03 | −3.420E−03 |
| C | 8.295E−04 | −2.872E−03 | −2.032E−04 | −3.737E−04 |
| D | −1.753E−04 | 5.492E−04 | −5.642E−05 | 2.055E−04 |
| E | 0.000E+00 | 0.000E+00 | 0.000E+00 | 0.000E+00 |
| F | 0.000E+00 | 0.000E+00 | 0.000E+00 | 0.000E+00 |
| G | 0.000E+00 | 0.000E+00 | 0.000E+00 | 0.000E+00 |
| H | 0.000E+00 | 0.000E+00 | 0.000E+00 | 0.000E+00 |
| J | 0.000E+00 | 0.000E+00 | 0.000E+00 | 0.000E+00 |
| Surface | | | | |
| No. | S8 | S9 | S10 | S11 |
| k | 4.382E−01 | −4.333E+00 | −9.000E+01 | −5.936E+00 |
| A | −1.739E−02 | −4.073E−02 | −5.724E−02 | −4.259E−02 |
| B | −1.830E−02 | 7.055E−03 | 2.840E−02 | 1.553E−02 |
| C | 1.310E−02 | 4.187E−03 | −6.799E−03 | −3.355E−03 |
| D | −1.776E−03 | −7.295E−04 | 4.245E−04 | 2.439E−04 |
| E | 0.000E+00 | 0.000E+00 | 0.000E+00 | 0.000E+00 |
| F | 0.000E+00 | 0.000E+00 | 0.000E+00 | 0.000E+00 |
| G | 0.000E+00 | 0.000E+00 | 0.000E+00 | 0.000E+00 |
| H | 0.000E+00 | 0.000E+00 | 0.000E+00 | 0.000E+00 |
| J | 0.000E+00 | 0.000E+00 | 0.000E+00 | 0.000E+00 |

Tables 11 to 12 below illustrate optical characteristic values and conditional expression values of the imaging lens systems 100 to 500 according to the first to fifth embodiments.

TABLE 11

| Optical | 1st | 2nd | 3rd | 4th | 5th |
|---|---|---|---|---|---|
| Characteristic | Emb. | Emb. | Emb. | Emb. | Emb. |
| f | 4.4485 | 4.4398 | 4.3612 | 4.4336 | 4.4760 |
| f1 | −12.7500 | −12.7302 | −50.4732 | −11.2267 | −6.6111 |
| f2 | 5.6902 | 5.7366 | 5.6675 | 5.7547 | 5.8443 |
| f3 | 4.9510 | 8.1244 | −36.2615 | 6.3881 | 4.9333 |
| f4 | −25.2416 | 19.0796 | 3.0506 | 6.7256 | 3.6219 |
| f5 | −5.9042 | −4.5154 | −2.6058 | −2.8942 | −2.7381 |
| TTL | 7.7138 | 7.7500 | 7.4912 | 7.7500 | 7.7500 |
| f-number | 2.0000 | 2.0000 | 2.0000 | 2.0000 | 2.0000 |
| IMGHT | 2.3000 | 2.2640 | 2.3000 | 2.3000 | 2.3000 |
| FOV | 57.5000 | 56.6000 | 57.6000 | 57.5000 | 57.4000 |

TABLE 12

| Conditional | 1st | 2nd | 3rd | 4th | 5th |
|---|---|---|---|---|---|
| Expression | Emb. | Emb. | Emb. | Emb. | Emb. |
| f/f4 | −0.1762 | 0.2327 | 1.4296 | 0.6592 | 1.2358 |
| f1/f2 | −2.2407 | −2.2191 | −8.9058 | −1.9509 | −1.1312 |
| f1/f3 | −2.5752 | −1.5669 | 1.3919 | −1.7574 | −1.3401 |
| f1/f4 | 0.5051 | −0.6672 | −16.5456 | −1.6693 | −1.8253 |
| f1/f5 | 2.1595 | 2.8192 | 19.3697 | 3.8791 | 2.4145 |
| f2/f4 | −0.2254 | 0.3007 | 1.8578 | 0.8556 | 1.6136 |
| f3/f4 | −0.1961 | 0.4258 | −11.8869 | 0.9498 | 1.3621 |
| (R3 + R5)/R10 | 5.3514 | 4.8229 | 4.1916 | 6.0507 | 6.9187 |
| (R5 + R9)/R10 | 4.2830 | 5.8952 | 0.0004 | 7.1749 | 9.7516 |
| (R3 + R9 + R10)/f2 | 2.4202 | 2.3419 | 1.7812 | 1.8152 | 2.7571 |
| Nd2/Nd5 | 1.2719 | 1.1746 | 1.0370 | 1.0703 | 1.2719 |
| \|V5 − V2\| | 28.0800 | 13.9000 | 8.2233 | 28.6501 | 28.0800 |

While this disclosure includes specific examples, it will be apparent after an understanding of the disclosure of this application that various changes in form and detail may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An imaging lens system comprising:
a first lens, a second lens, a third lens, a fourth lens, and a fifth lens sequentially disposed in ascending numerical order along an optical axis of the imaging lens system from an object side of the imaging lens system toward an imaging plane of the imaging lens system,
wherein the second lens has a positive refractive power and is made of a glass material,
the fifth lens is made of a plastic material, and
the imaging lens system satisfies the following conditional expression:
f-number<2.10
where f-number is an f-number of the imaging lens system.

2. The imaging lens system of claim 1, wherein the first lens has a negative refractive power.

3. The imaging lens system of claim 1, wherein the first lens has a concave object-side surface in a paraxial region thereof.

4. The imaging lens system of claim 1, wherein the second lens has a convex object-side surface in a paraxial region thereof.

5. The imaging lens system of claim 1, wherein the third lens has a convex object-side surface in a paraxial region thereof.

6. The imaging lens system of claim 1, wherein the fourth lens has a concave object-side surface in a paraxial region thereof.

7. The imaging lens system of claim 1, wherein the fifth lens has a negative refractive power.

8. The imaging lens system of claim 1, wherein the fifth lens has a convex object-side surface in a paraxial region thereof.

9. The imaging lens system of claim 1, wherein the imaging lens system satisfies the following conditional expression:
$$2. < f 1 / f 5 < 20.$$
where f1 is a focal length of the first lens, and f5 is a focal length of the fifth lens.

10. An imaging lens system comprising:
a first lens, a second lens, a third lens, a fourth lens, and a fifth lens sequentially disposed in ascending numerical order along an optical axis of the imaging lens system from an object side of the imaging lens system toward an imaging plane of the imaging lens system,
wherein the first lens has a negative refractive power,
the first lens has a convex image-side side surface in a paraxial region thereof or the third lens has a convex image-side surface in a paraxial region thereof, and
the imaging lens system satisfies the following conditional expression:
$$4. < ( R 3 + R 5 ) / R 10 < 8.$$
where R3 is a radius of curvature of an object-side surface of the second lens at the optical axis, R5 is a radius of curvature of an object-side surface of the third lens at the optical axis, and R10 is a radius of curvature of an image-side surface of the fifth lens at the optical axis.

11. The imaging lens system of claim 10, wherein the first lens has a concave object-side surface in a paraxial region thereof.

12. The imaging lens system of claim 10, wherein the second lens has a positive refractive power.

13. The imaging lens system of claim 10, wherein the second lens has a convex object-side surface in a paraxial region thereof.

14. The imaging lens system of claim 10, wherein the third lens has a convex object-side surface in a paraxial region thereof.

15. The imaging lens system of claim 10, wherein the fourth lens has a concave object-side surface in a paraxial region thereof.

16. The imaging lens system of claim 10, wherein the fifth lens has a negative refractive power.

17. The imaging lens system of claim 10, wherein the fifth lens has a convex object-side surface in a paraxial region thereof.

18. The imaging lens system of claim 10, wherein the imaging lens system satisfies the following conditional expression:
$$- 10. < f 1 / f 2 < - 1.$$
where f1 is a focal length of the first lens, and f2 is a focal length of the second lens.

19. The imaging lens system of claim 10, wherein the imaging lens system satisfies the following conditional expression:
$$- 3. < f 1 / f 3 < 2.$$
where f1 is a focal length of the first lens, and f3 is a focal length of the third lens.

20. The imaging lens system of claim 10, wherein the imaging lens system satisfies the following conditional expression:
$$2. < f 1 / f 5 < 20.$$
where f1 is a focal length of the first lens, and f5 is a focal length of the fifth lens.
